(19) United States
(12) Patent Application Publication
(10) Pub. No.: US 2004/0001740 A1
(43) Pub. Date: Jan. 1, 2004

(54) Cutting insert for a drill, and boring tool using this insert

(76) Inventors: Pierre Rigolet, Montholier (FR); Andre Vaivre, Poligny (FR); Marc Badey, Chamole (FR); Dominique Maurice, Poligny (FR); Sylvain Lamy, Poligny (FR)

Correspondence Address: CANTOR COLBURN, LLP, 55 GRIFFIN ROAD SOUTH, BLOOMFIELD, CT, 06002

(21) Appl. No.: 10/461,533

(22) Filed: Jun. 12, 2003

(30) Foreign Application Priority Data
Jun. 14, 2002 (FR) 02.07380

(51) Int. Cl. B23B 51/02

(52) U.S. Cl. 408/227

(57) ABSTRACT

This cutting insert, designed to be inserted into the cutting head of a drill or other similar rotary boring tool, has an arced overall shape, with a concave flank and a convex flank. These flanks are connected by a base face, by two straight end edges one of which is able to act as a guide for the drill and, at the opposite end to the base face, by at least one cutting part, with at least one cutting edge and/or at least one tip. Also described is a boring tool, the cutting head of which comprises such arced inserts, arranged laterally, and associated with a central insert.

### BACKGROUND OF THE INVENTION

The present invention relates to the field of drills and other similar rotary boring tools, the cutting part of which comprises attached cutting inserts. More specifically, the invention relates to a cutting insert characterized by a special geometry for a drill or other similar rotary boring tool, the insert being designed to be inserted into the cutting head of the boring tool. This invention also relates to a rotary boring tool, of the drill or similar kind, the cutting part of which uses such cutting inserts.

### DESCRIPTION OF THE PRIOR ART

In a conventional way, the cutting inserts, for example made of carbide, attached to the rotary boring tools, have a flat overall shape of polygonal outline. A conventional cutting insert is depicted in FIGS. 1 to 3 of the attached schematic drawing, which show, more specifically:

FIG. 1: a perspective view of a conventional cutting insert;

FIG. 2: a front view of the cutting insert of FIG. 1;

FIG. 3: a side view of the same cutting insert.

Of pentagonal overall shape, this cutting insert 1 has a tip 2 and two cutting edges 3 and 4 that converge toward the central part 2. The two opposed lateral large faces 5 of the insert 1 here are flat pentagonal faces.

Such cutting inserts can be used in particular to produce the cutting part of a drill, like the one described in French patent No. 2738762 or the corresponding European patent No. 0763649, in the name of the Applicant.

These documents describe a drill head that takes three cutting inserts, of the shape previously described, namely a central cutting insert arranged in a diametral direction of the drill head, and two lateral cutting inserts arranged one on each side of the central insert, parallel or not parallel thereto. These three cutting inserts, which are flat, form six cutting edges in total. They also define, via their edges situated at the periphery of the drill, six bearing or guiding points which are preferably concentric and thus, during boring, precisely guide the drill in the hole produced.

In such a drill comprising three inserts, which may or may not be mutually parallel, the space available for making longitudinal grooves for removing the dust remains limited. What is more, the orientation of the cutting edges of the two lateral inserts is not optimized, and gives rise to friction.

### SUMMARY OF THE INVENTION

It is an object of the present invention to avoid these disadvantages by providing an improved cutting insert which, used particularly on a drill of the kind considered here, allows its performance to be improved, particularly from the point of view of the discharge of the dust and the cutting efficiency, while at the same time maintaining the advantages relating to the precision with which the drill is guided.

To this end, the first subject of the invention is a cutting insert for a drill, or other similar rotary boring tool, the insert being designed to be inserted into the cutting head of the boring tool, and this cutting insert essentially being characterized in that it has an arced overall shape, with a concave flank and a convex flank that are connected by a base face, by two straight end edges, at least one of which is able to guide the drill or other boring tool and, at the opposite end to the base face, by at least one cutting part, with at least one cutting edge and/or at least one tip.

Thus, the invention proposes a cutting insert essentially characterized by an arced shape, and designed to be fitted into a housing of corresponding shape formed in the cutting head of a drill or other similar boring tool. Such an arced cutting insert can be used in particular in place of each, usually flat, lateral cutting insert of a drill head comprising three inserts, of the kind recalled hereinabove, in this application affording a certain number of advantages as specified hereinafter.

The arced shape of the cutting insert that is the subject of the invention results from its being delimited by two flanks (or lateral faces), one concave and the other convex. According to one embodiment of this cutting insert, the concave flank consists of a first cylindrical surface and the convex flank consists of a second cylindrical surface, the two cylindrical surfaces being coaxial and therefore running parallel to one another, at a distance apart that defines a constant thickness for the arced cutting insert; the shape of the insert, projected onto its base plane, thus corresponds to an arc of a circle. However, variations are conceivable, in which this shape corresponds to an arc of an ellipse or of some other curve, or alternatively to a compilation of two or more arcs of different types.

The alternative forms of this arced cutting insert result, in particular, from the various possibilities there are in producing its cutting part, opposite its base face, the latter preferably being a simple flat face.

According to one embodiment, the arced insert has a continuous single cutting part provided with two rising curved cutting edges that start out from the respective tops of the two end edges of the insert and that converge toward the region of a tip. The two curved cutting edges may here be of equal length, the arced insert thus having an overall appearance that is symmetric with respect to a mid-plane. The two curved cutting edges may also be of unequal length, and thus converge toward the region of an off-centered tip, the arced insert in this case having an asymmetric appearance.

According to another embodiment, the arced insert has two separate cutting parts with respective cutting edges, starting out from the respective tops of the two end edges of the insert and that are separated from one another by an intermediate recess.

According to yet another embodiment, the arced insert has a cutting part provided with at least one tip of the “concrete breaker” type, particularly two tips of this type situated toward the ends of the cutting part of the insert.

Such tips may be combined with at least one cutting edge present in this case in the region or regions intermediate between the tips, the cutting edge or edges thus connecting the tips. According to another possibility, the tips are not combined with cutting edges, in which case the cutting part of the arced insert has at least one recess situated between the tips.

According to another advantageous feature, the arced insert comprises, on its concave flank or on its convex flank, a stud or index for positioning this cutting insert in its housing, at the cutting head of the drill or other similar rotary boring tool.

Another subject of the present invention is a rotary boring tool of the drill or similar kind, having a cutting head in which is inserted at least one insert of arced shape as defined hereinabove, the straight end edges of the or each insert being parallel to the central axis of the tool. More specifically, this boring tool comprises, at its cutting head, on the one hand, a central or main insert of flat shape or made up of flat parts, and, on the other hand, arranged on the sides of the central or main insert, or around this central or main insert, arced inserts the end edges of which lie at the periphery of the cutting head of the tool, the convex flanks of all the arced inserts facing toward the central or main insert.

According to one embodiment of such a boring tool, its cutting head comprises a flat central insert arranged across a diameter of said head, and two arced lateral inserts arranged one on each side of the flat central insert, the convex flanks of the two arced inserts facing respectively toward the two opposed lateral large faces of the flat central insert.

According to another embodiment of such a boring tool, its cutting head comprises a star-shaped central insert, with flat radial arms, centered on the axis of the boring tool, and a plurality of arced lateral inserts placed in the sectors defined between the radial arms or in the continuation of the radial arms of the central insert, the convex flanks of the various arced inserts facing toward the center of the central insert.

In all cases, the cutting head of the boring tool may comprise, at its periphery, longitudinal grooves for the removal of drilling dust, these grooves being situated in the region of the concavity of each of the arced cutting inserts.

In particular, the invention allows the production of boring tools with three inserts, these being one central insert and two lateral inserts, mirroring the general principle of the aforementioned French patent No. 2738762 and European patent No. 0763649, but substituting, for the two flat lateral inserts of these patents, two arced lateral inserts as defined hereinabove. The boring tool thus produced maintains the advantage of being able to have six concentric bearing or guiding points, consisting of the two ends of the flat central insert and of the two ends of each of the two arced lateral inserts, for perfect guidance of the tool in the hole that is being bored. By virtue of the use of inserts of arced shape, this boring tool is further appreciably improved in the following respects:

a) Improvement in the Discharge of Drilling Dust:

The presence of the arced cutting inserts makes it possible, as indicated hereinabove, to form in the cutting head additional discharge grooves (secondary grooves) that are added to the existing discharge grooves (main grooves) while at the same time allowing these main grooves to be enlarged.

This makes it possible to optimize the cutting/discharge space by adapting the size of the arced lateral inserts and their arrangement (angular and heightwise) with respect to those of the central insert.

b) Improvement in the Boring Capability:

By better orientation of the cutting edges of the arced lateral inserts (by comparison with the cutting edges of flat lateral inserts according to the aforementioned patents) because these cutting edges are practically perpendicular to the direction of the linear speed due to the rotation of the drill, an improvement in the cutting function and a reduction in friction are obtained.

c) Improvement in the Strength of the Cutting Part at Work:

The (concave or convex) curvature of the lateral faces of the arced insert means that this insert cannot be expelled from its housing formed in the cutting head of the tool by a force imposed on the side of the insert. In other words, the arced insert, because of its shape, has better shear strength, as compared with a flat insert for which the shear strength is given solely by the mechanical characteristics of the brazed joint used to fix the insert into its housing.

d) Easier Fitting of the Insert into its Housing:

When the cutting part of the drill is manufactured, the convex and/or concave faces of the arced inserts may act as guides for the easy placement of these inserts in their housings. This advantage is further strengthened if there is a stud or index present on one of the flanks of the arced insert, particularly on its convex flank, the stud or index acting as a visual pointer and making final positioning of the insert in its housing easier.

### BRIEF DESCRIPTION OF THE DRAWINGS

In any event, the invention will be better understood with the aid of the description that follows, with reference to the attached schematic drawing which, by way of examples, depicts embodiments of this cutting insert and of the drills using such cutting inserts:

FIGS. 1 to 3 (already mentioned) show a flat cutting insert according to the prior art;

FIG. 4 is a perspective view of a first embodiment of the arced cutting insert according to the invention;

FIG. 5 is a view from above of the cutting insert of FIG. 4;

FIG. 6 is a perspective view of a second embodiment of the arced cutting insert according to the invention;

FIG. 7 is a view from above of the cutting insert of FIG. 6;

FIG. 8 is a perspective view of a third embodiment of the arced cutting insert according to the invention;

FIG. 9 is a view from above of the cutting insert of FIG. 8;

FIG. 10 is a perspective view of a fourth embodiment of the arced cutting insert according to the invention;

FIG. 11 is a side view of the cutting insert of FIG. 10;

FIG. 12 is a view from above of the cutting insert of FIGS. 10 and 11;

FIG. 13 is a perspective view of an alternative form of the cutting insert of FIGS. 10 to 12;

FIG. 14 is a perspective view of another embodiment of the arced cutting insert according to the invention;

FIG. 15 is a view from above of the cutting insert of FIG. 14;

FIG. 16 is a perspective view of a last embodiment of the arced cutting insert according to the invention;

FIG. 17 is a view from above of the cutting insert of FIG. 16;

FIG. 18 is a perspective view of a drill cutting head with arced inserts according to the invention;

FIG. 19 is an end-on view of the cutting head of FIG. 18;

FIG. 20 is a perspective view of another drill cutting head, with arced inserts according to the invention;

FIG. 21 is an end-on view of the cutting head of FIG. 20.

### DESCRIPTION OF THE PREFERRED EMBODIMENTS

FIGS. 4 and 5 show a first embodiment of an arced cutting insert 6 according to the present invention. This cutting insert 6 may be considered as having been “cut” from a hollow cylinder. It thus comprises a concave flank 7, consisting of a first cylindrical surface, and a convex flank 8, consisting of a second cylindrical surface, the two cylindrical surfaces 7 and 8 having the same axis A and thus running parallel to one another, at a distance apart that defines the constant thickness e of the cutting insert 6.

The two flanks 7 and 8 of the cutting insert 6 are connected by a flat base face 9, which runs in a plane perpendicular to the axis A.

The two flanks 7 and 8 of the cutting insert 6 are also connected by two straight end edges 10 and 11 which run parallel to the axis A, and therefore perpendicular to the base face 9. Finally, the two flanks 7 and 8 of the cutting insert 6 are connected, at the opposite end to the base face 9, by a cutting part, in this instance a single one. The cutting part has two curved and rising cutting edges 12 and 13 starting out from the respective tops of the two end edges 10 and 11 and converging toward the region of a central tip 14, the two cutting edges 12 and 13 here being of equal length.

In detail, the first cutting edge 12 lies between a curved cutting face 15 and a curved clearance face 16. The second cutting edge 13 lies between a curved cutting face 17 and a curved clearance face 18. In the region of the tip 14, the two clearance faces 16 and 18 are adjacent, and meet along a line 19.

FIGS. 6 and 7, in which the elements that correspond to those of FIGS. 4 and 5 are denoted by the same references, show a second embodiment of an arced cutting insert 6, differing from the previous one in the asymmetric arrangement of the two cutting edges 12 and 13 of the single cutting part. The two cutting edges 12 and 13 here are actually of unequal length, the first cutting edge 12 having, for example, a length appreciably longer than that of the second cutting edge 13. These two cutting edges 12 and 13 still converge toward the region of a tip 14, but this tip 14 here is off-centered.

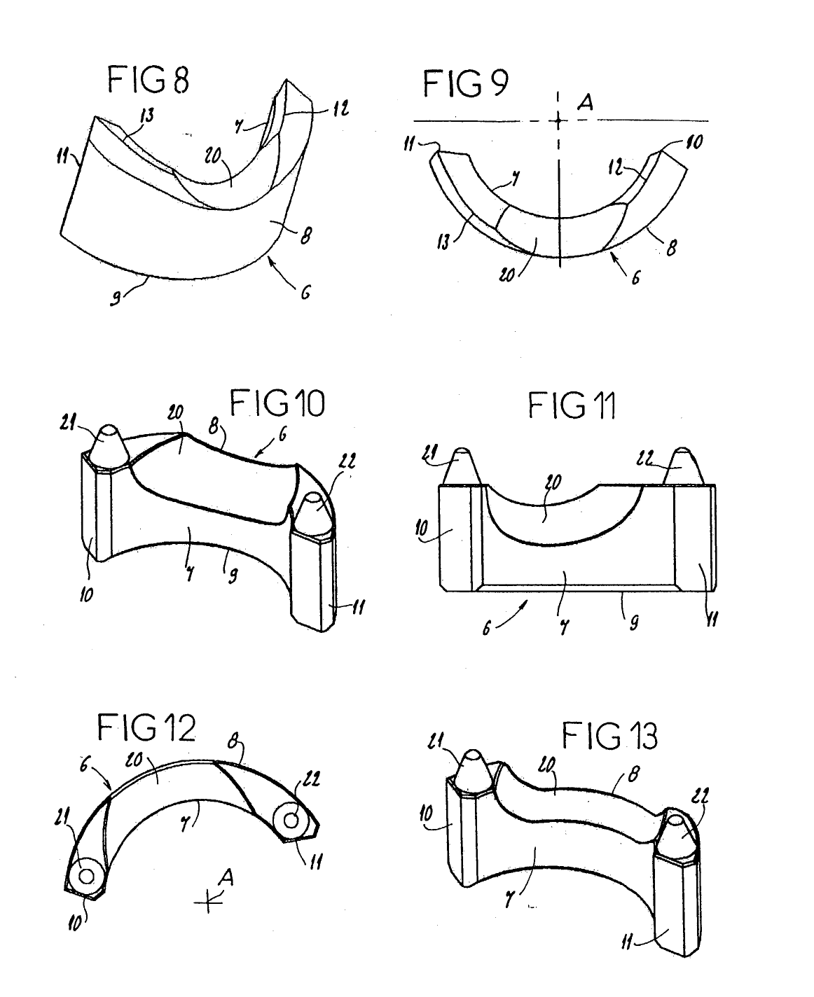

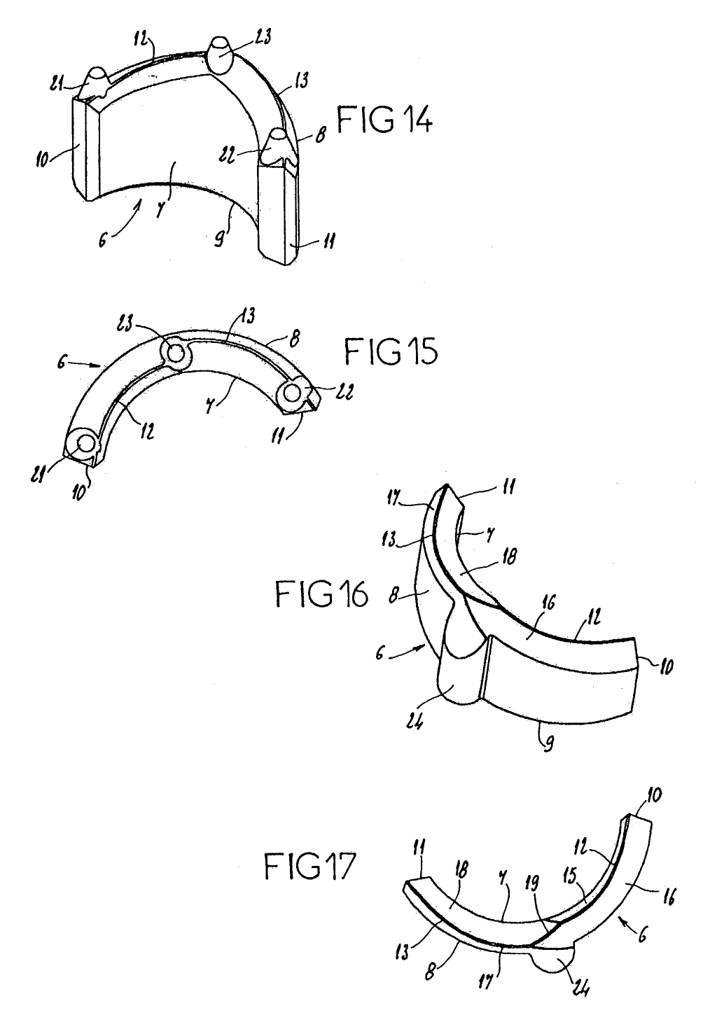

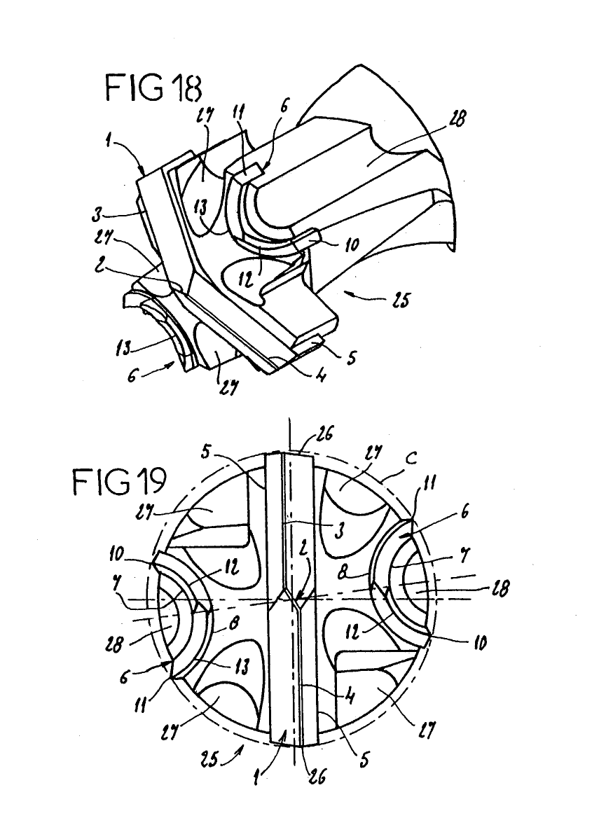

FIGS. 8 to 13 show embodiments in which the arced cutting inserts 6 have double cutting parts.

More specifically, FIGS. 8 and 9 show an embodiment in which the arced cutting insert 6 has two separate cutting parts, with respective cutting edges 12 and 13, the first cutting edge 12 starting from the top of the end edge 10 and the second cutting edge 13 starting from the top of the other end edge 11. The two cutting parts, and therefore the two cutting edges 12 and 13, are separated by an intermediate recess 20.

FIGS. 10, 11 and 12 show another embodiment in which the arced cutting insert 6 has two separate cutting parts consisting respectively of two tips 21 and 22 of the “concrete breaker tip” type. The two tips 21 and 22 are situated toward the respective tops of the two end edges 10 and 11 of the insert 6, the axes of these tips being inclined or parallel to the axis A. The two cutting parts and therefore the two tips 21 and 22 are, once again, separated by an intermediate recess 20, of asymmetric appearance.

FIG. 13 illustrates an alternative form of this arced cutting insert 6 with two tips 21 and 22, in which alternative form the intermediate recess 20 is symmetric and of a different appearance.

As shown by FIGS. 14 and 15, that relate to another embodiment stemming from the preceding ones, the number of tips of the “concrete breaker” type may be higher. In this example, the arced cutting insert 6 has two tips 21 and 22 situated toward its two ends, and a third “concrete-breaker” tip 23 situated in the central part, that is to say between the first two tips 21 and 22.

In addition, FIGS. 14 and 15 show that instead of intermediate recesses, curved cutting edges 12 and 13 may run between the tips 21, 22 and 23, and thus provide the connection between these tips.

FIGS. 16 and 17 show a last embodiment in which the arced cutting insert 6, here with a cutting part comprising two cutting edges 12 and 13, comprises on its convex flank 8 a stud or index 24 that serves to position the insert 6 in its housing on the cutting head of a drill or other similar rotary boring tool.

The next FIGS. 18 to 21, illustrate the application of the arced cutting inserts 6 as described hereinabove to drill cutting heads.

FIGS. 18 and 19 show a cutting head 25 of a drill, of cylindrical overall shape ending in a conical surface, that takes three cutting inserts.

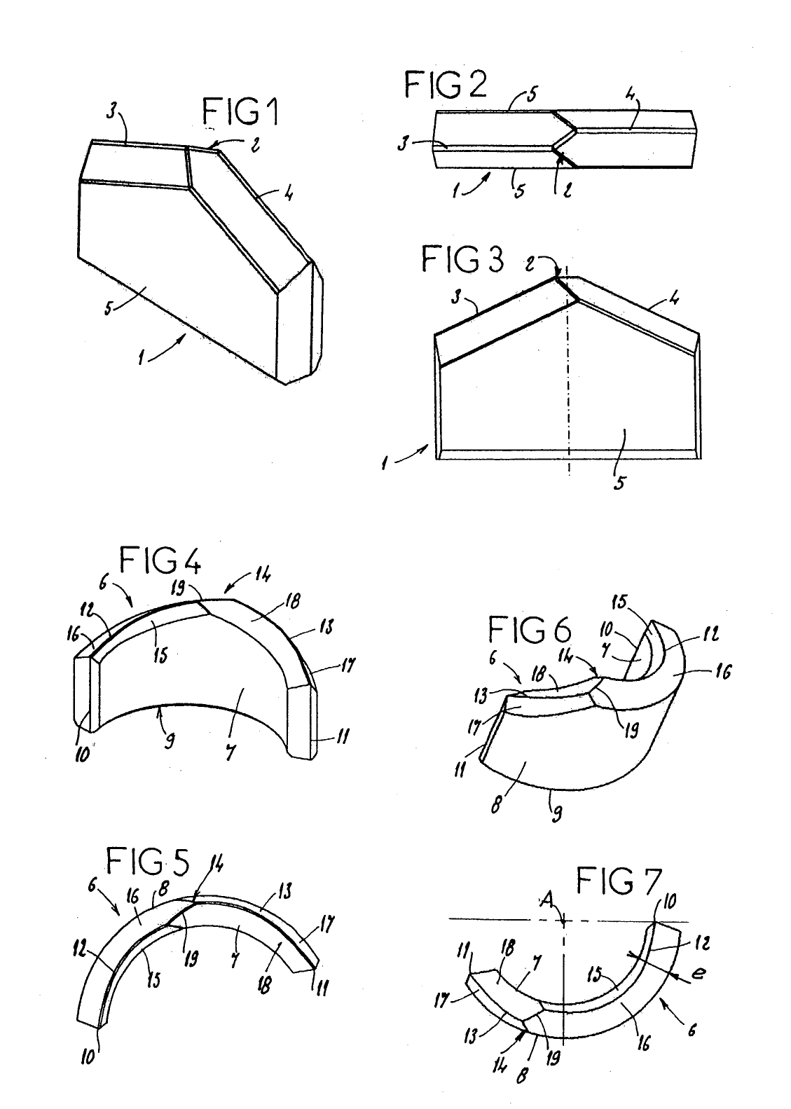

The first cutting insert, known as the central or main insert, is a flat insert 1 (like the one depicted in FIGS. 1 to 3), arranged diametrically in a corresponding housing in the shape of a straight groove, formed across a diametral plane of the cutting head 25. The other two cutting inserts, known as lateral inserts, are arced inserts 6 as described hereinabove, arranged one on each side of the central insert 1, in corresponding housings in the cutting head 25. The respective convex flanks 8 of the two arced inserts 6 face toward the two opposed lateral large faces 5 of the flat central insert 1.

The flat central insert 1 has two cutting edges 3 and 4 that converge toward a point 2 situated on the central axis of the cutting head 25 and of the drill. Each lateral insert 6 has two other cutting edges 12 and 13 which means that the cutting head 25 has, in total, six cutting edges. In the example illustrated, the cutting edges 12 and 13 of the arced lateral inserts 6 are situated more or less at the same level as the cutting edges 3 and 4 of the flat central insert 1.

Furthermore, the two end edges 26 of the flat central insert 1, and the respective end edges 10 and 11 of the two arced lateral inserts 6 are parallel to the axis of the cutting head 25 and all lie more or less on the same circle C centered on the axis of the cutting head 25 to form six bearing and guiding points for the drill in a hole being bored, the diameter of which then corresponds to that of the circle C. As an alternative, the end edges 10 and/or 11 of the two arced lateral inserts 6 may be set back from the circle that has, as its diameter, the line joining the two end edges 26 of the flat central insert 1, or alternatively outside this circle.

Four longitudinal grooves 27 are hollowed out from the cylindrical lateral surface of the cutting head 25, and open onto the conical terminal face, in the spaces there are between the central cutting insert 1 and the two lateral cutting inserts 6. In addition, two more longitudinal grooves 26 are hollowed out from the periphery of the cutting head 25, in the region of the concavity of the two arced lateral cutting inserts 6. All these grooves 27 and 28, of which here there are six in total, contribute to the removal of drilling dust.

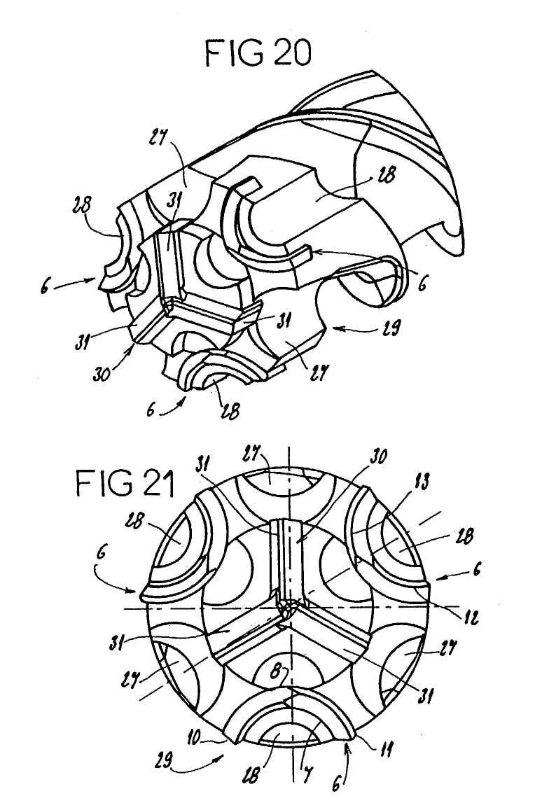

FIGS. 20 and 21 show another cutting head 29 of a drill, that takes a central cutting insert 30, in the form of a three-armed star 31, and three arced lateral cutting inserts 6, as described hereinabove.

The central cutting insert 30 is centered on the axis of the drill, its three arms 31 of flat shape being oriented radially. The ends of the three arms 31 of the central insert 30 are situated on a circle the diameter of which is smaller than that of the cutting head 29, and smaller than the diameter of the circle through which the end edges 10 and 11 of the three arced inserts 6 pass.

These three arced inserts 6 are arranged respectively in the three 120° sectors defined between the arms 31 of the central insert 30, the convex flanks 8 of the various arced inserts 6 facing toward the center of the central insert 30.

In addition, in the embodiment illustrated, the central cutting insert 30 is situated “higher up” than the arced cutting inserts 6, this configuration leading to a cutting head 29 said to be “with pilot”, this pilot consisting of the raised central insert 30, the diameter of which is smaller than the nominal diameter of the drill, the diameter of the bored hole being defined by the outside edges 10 and 11 of the arced lateral inserts 6.

Finally, the cutting head 29 has, for removing the drilling dust, three peripheral grooves 27 situated in line with the arms 31 of the central cutting insert 30, and three additional peripheral grooves 28 formed in the concavities of the three arced cutting inserts 6.

It would not constitute a departure from the scope of the invention as defined in the attached claims if the detailed shape of the arced cutting inserts or their arrangement were to be modified, in particular:

if any arced shape, not only inscribed inside a cylinder on a circular base, but also in the form of an arc of an ellipse or the like, or alternatively resulting from the compilation of two or more arcs of different characteristics were to be provided;

if an arced insert were to be produced with two cutting edges arranged in such a way that the clearance faces and the respective cutting faces all met at a tip situated in the central part of the insert;

if an arced insert were to be produced with just one cutting edge, and therefore one cutting face and one clearance face;

if a positioning stud or index were to be provided on arced cutting inserts of any configuration, with cutting edges and/or tips;

if use were to be made of arced cutting inserts in greater or fewer number, and in variable arrangements (both angular and heightwise) on the cutting heads of drills, in conjunction with a central or main insert with variable characteristics, or even without a central or main insert;

if dust removal grooves were to be provided, or not, on the drill in the region of the concavity of the arced cutting inserts;

if these arced cutting inserts were to be destined for drilling or rotary boring tools of all kinds, suited to various types of material to be bored;

if non-linear cutting edges with geometry based on that of the arced cutting inserts already described were to be incorporated into a one-piece insert, particularly made of carbide, intended to be welded or brazed at the end of the drill, or other similar rotary boring tool, so as to produce the cutting part thereof.

1. A cutting insert for a drill, or other similar rotary boring tool, the insert being designed to be inserted into the cutting head of the boring tool, and which has an arced overall shape, with a concave flank and a convex flank that are connected by a base face, by two straight end edges, at least one of which is able to guide the drill or other boring tool and, at the opposite end to the base face, by at least one cutting part, with at least one cutting edge and/or at least one tip.

2. The cutting insert as claimed in claim 1, wherein the concave flank consists of a first cylindrical surface and the convex flank consists of a second cylindrical surface, the two cylindrical surfaces being coaxial and therefore running parallel to one another, at a distance apart that defines a constant thickness for the arced cutting insert.

3. The cutting insert as claimed in claim 1 or 2, wherein the base face is a flat face.

4. The cutting insert as claimed in any one of claims 1 to 3 and which has a continuous single cutting part provided with two rising curved cutting edges that start out from the respective tops of the two end edges of the insert and that converge toward the region of a tip.

5. The cutting insert as claimed in claim 4, wherein the two curved cutting edges are of equal length, the arced insert also having an overall appearance that is symmetric with respect to a mid-plane.

6. The cutting insert as claimed in claim 4, wherein the two curved cutting edges are of unequal length, and thus converge toward the region of an off-centered tip, the arced insert having an asymmetric appearance.

7. The cutting insert as claimed in any one of claims 1 to 3, and which has two separate cutting parts with respective cutting edges, starting out from the respective tops of the two end edges of the insert and that are separated from one another by an intermediate recess.

8. The cutting insert as claimed in any one of claims 1 to 3 and which has a cutting part provided with at least one tip of the “concrete breaker” type, particularly two tips of this type situated toward the ends of the cutting part of the insert.

9. The cutting insert as claimed in claim 8, wherein the tips are combined with at least one cutting edge present in the region or regions intermediate between the tips, the cutting edge or edges thus connecting the tips.

10. The cutting insert as claimed in claim 8, wherein the cutting part has at least one recess situated between the tips.

11. The cutting insert as claimed in any one of claims 1 to 10 and which comprises, on its concave flank or on its convex flank, a stud or index for positioning this cutting insert in its housing, at the cutting head of a drill or other rotary boring tool.

12. A rotary boring tool of the drill or similar kind, and which has a cutting head into which is inserted at least one cutting insert of arced shape as claimed in any one of claims 1 to 11, the straight end edges of the or each insert being parallel to the central axis of the tool.

13. The boring tool as claimed in claim 12, and which comprises, at its cutting head, on the one hand, a central or main insert of flat shape or made up of flat parts, and, on the other hand, arranged on the sides of the central or main insert, or around this central or main insert, arced inserts the end edges of which lie at the periphery of the cutting head of the tool, the convex flanks of all the arced inserts facing toward the central or main insert.

14. The boring tool as claimed in claim 13, and of which the cutting head comprises a flat central insert arranged across a diameter of said head, and two arced lateral inserts arranged one on each side of the flat central insert, the convex flanks of the two arced inserts facing respectively toward the two opposed lateral large faces of the flat central insert.

15. The boring tool as claimed in claim 14, and which has six concentric bearing or guiding points consisting of the two ends of the flat central insert and of the two ends of each of the two arced lateral inserts.

16. The boring tool as claimed in claim 13 and of which the cutting head comprises a star-shaped central insert, with flat radial arms, centered on the axis of the boring tool, and a plurality of arced lateral inserts placed in the sectors defined between the radial arms or in the continuation of the radial arms of the central insert, the convex flanks of the various arced inserts facing toward the center of the central insert.

17. The boring tool as claimed in claim 16, wherein the ends of the arms of the central insert are situated on a circle of a diameter smaller than that of the cutting head, the central insert being raised relative to the arced lateral inserts, so as to produce a cutting head “with pilot”.

18. The boring tool as claimed in any one of claims 13 to 17 and which comprises, at its periphery, longitudinal grooves for the removal of drilling dust, these grooves being situated in the region of the concavity of each of the arced cutting inserts.

19. A rotary boring tool, of the drill or similar kind, and which comprises non-linear cutting edges with a geometry based on that of the cutting inserts as claimed in any one of claims 1 to 11, incorporated into a one-piece insert welded or brazed to the end of a tool, so as to form the cutting part of the latter.
